(19) United States
(12) Patent Application Publication
(10) Pub. No.: US 2018/0208195 A1
(43) Pub. Date: Jul. 26, 2018

(54) COLLABORATIVE RISK CONTROLLER FOR VEHICLES USING V2V

(71) Applicant: PCMS Holdings, Inc., Wilmington, DE (US)

(72) Inventors: Timothy Hutcheson, Pensacola, FL (US); Samian Kaur, Plymouth Meeting, PA (US)

(21) Appl. No.: 15/875,777

(22) Filed: Jan. 19, 2018

Related U.S. Application Data
(60) Provisional application No. 62/448,604, filed on Jan. 20, 2017.

(51) Int. Cl. B60W 30/095; H04W 4/46; G08G 1/16; G05D 1/00; G05D 1/02

(52) U.S. Cl. CPC B60W 30/0953; H04W 4/46; G08G 1/166; G05D 2201/0213; G05D 1/0214; B60W 2550/408; G05D 1/0088

(57) ABSTRACT

The automated driving behavior of a self-driving vehicle may be controlled. In some cases, a system may determine a collision risk for the first self-driving vehicle. The first vehicle may receive from one or more nearby vehicles a collision risk assessment value determined by said vehicle. The first vehicle may determine an aggregate collision risk score based on the determined collision risk and the received collision risk assessments. Responsive to a determination that the aggregate collision risk score has changed relative to a previously calculated aggregate collision risk score, the first vehicle may adapt at least one of its self-driving parameters to control automated driving behavior.

### CROSS-REFERENCE TO RELATED APPLICATIONS

The present application is a non-provisional filing of, and claims benefit under 35 U.S.C. § 119(e) from, U.S. Provisional Patent Application Ser. No. 62/448,604, filed Jan. 20, 2017, entitled “COLLABORATIVE RISK CONTROLLER FOR VEHICLES USING V2V”, which is incorporated herein by reference in its entirety.

### TECHNICAL FIELD

This disclosure relates to systems and methods for connected vehicles. More specifically, this disclosure relates to systems and methods for controlling automated driving behavior of self-driving vehicles.

### BACKGROUND

It is estimated that the cost of vehicle accidents in the United States exceeds $300 billion per year, with more than 4 people killed per hour in the US. Autonomous vehicles (AVs) are expected to have a major impact on the safety of our highways, but are not themselves without risk. As transportation moves into the autonomous vehicle era, understanding risks will become an increasingly important aspect of safe vehicle operation when a human is not at the controls. For example, it will be important for an AV to know the risks associated with a merging vehicle, which might have a mechanical issue or an algorithm issue related to firmware, as events play out in real-time. It will also be important for an AV to estimate the risk of an approaching non-AV as it might be necessary for the AV to adopt a more conservative response to a non-AV that has a recent history of risk. Conversely, an AV may develop a risk profile derived from its usage history or algorithms that would allow a non-AV driver to interact with it more safely.

Modifying an AV's driving behavior based on detected characteristics of another vehicle has been discussed in US Patent Publication 2014/0236414. Analysis of the driving behavior of vehicles based on V2V communications has been discussed in U.S. Pat. No. 9,147,353.

At the present, there are no known solutions which address the above referenced problems in real-time, or are implemented at the vehicle level.

### SUMMARY

Described herein are systems and methods related to a collaborative risk controller for self-driving vehicles.

In one embodiment, there is a method to change an automated driving behavior of a first self-driving vehicle, comprising: determining, at a first self-driving vehicle, a collision risk for the first self-driving vehicle; receiving, at the first self-driving vehicle, from at least a second vehicle, a collision risk assessment value determined by each of the at least second vehicles, using vehicle-to-vehicle communications; determining an aggregate collision risk score based on the first self-driving vehicle's determined collision risk and the collision risk assessment received from at least the second vehicle; and responsive to a determination that the aggregate collision risk score has changed relative to a previously calculated aggregate collision risk score, adapting a self-driving parameter of the first self-driving vehicle.

In one embodiment, a method includes determining a collision risk for a first self-driving vehicle based on a present risk from each vehicle of a first plurality of vehicles. The method also includes receiving, at the first self-driving vehicle, a collision risk assessment value from each vehicle of a second plurality of vehicles. The method also includes calculating, at the first self-driving vehicle for a first time window, a historical collision risk for a third plurality of vehicles. The method also includes determining an aggregate collision risk score based on the first self-driving vehicle's determined collision risk, the received collision risk assessment values, and the calculated historical collision risk. The method also includes responsive to the determination that the aggregate collision risk score has increased relative to a previously calculated aggregate collision risk score, adapting a self-driving parameter of the first self-driving vehicle to a more conservative level.

In one embodiment, a method includes determining, at a risk assessment controller of a first self-driving vehicle, a collision risk for the first self-driving vehicle based on a present risk from each vehicle of a first plurality of vehicles. The method also includes receiving, at the first self-driving vehicle, a collision risk assessment value from each vehicle of a second plurality of vehicles. The method also includes calculating, at the first self-driving vehicle for a first time window, a historical collision risk for a third plurality of vehicles. The method also includes determining an aggregate collision risk score based on the first self-driving vehicle's determined collision risk, the received collision risk assessment values, and the calculated historical collision risk. The method also includes, responsive to the determination that the aggregate collision risk score has changed relative to a previously calculated aggregate collision risk score, the risk assessment controller of the first self-driving vehicle adapting a self-driving parameter of the first self-driving vehicle.

In one embodiment, a method includes determining at least one ego-vehicle environment parameter for the first self-driving vehicle. The method also includes receiving at least one neighbor vehicle environment parameter from at least a first neighboring vehicle using vehicle-to-vehicle communications. The method also includes determining at least one situational base parameter based on the at least one ego-vehicle environment parameter, received at least neighbor vehicle environment parameter, and at least one road condition received from a cloud database. The method also includes, responsive to the determination that a second vehicle has significant deviation relative to the at least one situational base parameter, adapting a self-driving parameter of the first self-driving vehicle.

In one embodiment, a method includes determining, at a risk assessment controller of the first self-driving vehicle, a collision risk for the first self-driving vehicle. The method also includes receiving, at the first self-driving vehicle, from at least a second vehicle, a collision risk assessment value determined by each of the at least second vehicles, using vehicle-to-vehicle communications. The method also includes determining an aggregate collision risk score based on the first self-driving vehicle's determined collision risk and the collision risk assessment received from at least the second vehicle. The method also includes, responsive to a determination that the aggregate collision risk score has changed relative to a previously calculated aggregate collision risk score, transmitting an indication of changed perceived collision risk using vehicle-to-vehicle communications, from the first self-driving vehicle to at least the second vehicle.

In one embodiment, a method includes calculating, at a risk assessment controller of a first vehicle, based at least in part on sensor data of a first sensor of the first vehicle, a self-vehicle collision risk score. The method also includes transmitting via V2V the first vehicle's calculated self-vehicle collision risk score, to at least a second vehicle. The method also includes receiving, responsive to the transmission, a collision risk score from at least a second vehicle. The method also includes determining, at the risk assessment controller, an aggregate collision risk score based on the self-vehicle collision risk score and the at least one received collision risk score. The method also includes, responsive to the aggregate collision risk score, adapting a current driving mode of the first vehicle.

In some embodiments, there may be a system comprising a processor and a non-transitory storage medium storing instructions operative, when executed on the processor, to perform functions including those set forth above, as well as others.

In one embodiment, a system may comprise a risk assessment controller, including a transmitter, a receiver, a risk classification module, a sensor module, and a driving mode controller module.

### BRIEF DESCRIPTION OF THE DRAWINGS

A more detailed understanding may be had from the following description, presented by way of example in conjunction with the accompanying drawings in which like reference numerals in the figures indicate like elements, and wherein:

FIG. 1 illustrates a block diagram of one embodiment of a simplified negative feedback model.

FIG. 2 illustrates a block diagram of one embodiment of a risk assessment controller.

FIG. 3A illustrates an embodiment of a typical vehicle sensor system.

FIG. 3B illustrates a zoomed in portion of FIG. 3A.

FIG. 4A illustrates properties of one embodiment of a controller, in accordance with the present disclosure.

FIG. 4B illustrates more detailed properties of one embodiment of a controller, in accordance with the present disclosure.

FIG. 4C illustrates a sequence diagram for operation of the controller of FIG. 4B, according to an embodiment.

FIG. 5 illustrates one embodiment of a car radar RA neural network, according to an embodiment.

FIG. 6 illustrates one embodiment of a decay function for remnant risk factors.

FIG. 7A illustrates a first stage of an exemplary scenario, according to an embodiment.

FIG. 7B illustrates a second stage of an exemplary scenario, according to an embodiment.

FIG. 7C illustrates a third stage of an exemplary scenario, according to an embodiment.

FIG. 8 illustrates an exemplary wireless transmit/receive unit (WTRU) that may be employed as a component of a risk assessment controller in some embodiments.

FIG. 9 illustrates an exemplary network entity that may be employed in some embodiments.

### DETAILED DESCRIPTION

A detailed description of illustrative embodiments will now be provided with reference to the various Figures. Although this description provides detailed examples of possible implementations, it should be noted that the provided details are intended to be by way of example and in no way limit the scope of the application.

Note that various hardware elements of one or more of the described embodiments are referred to as “modules” that carry out (i.e., perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable by those of skill in the relevant art for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

Present vehicle collision avoidance systems estimate the probability of collision with another vehicle, issue warnings and alerts, and in some cases even apply the brakes. But they do not in general communicate that information to surrounding vehicles, as they presently have no reason for doing so. The present disclosure addresses collision avoidance as a collaborative process, informed by prior knowledge of historical risk collected from surrounding vehicles.

For AV operation, there is no human-in-the-loop making qualitative judgements about surrounding vehicle behaviors. Each nearby vehicle is assumed to operate according to well-known and accepted rules. For the foreseeable future, AVs will be operated in mixed autonomy—a collection of AVs, semi-AVs, and non-AV with no autonomy at all. Vehicles in an AV mode may not always make the correct assumptions regarding non-AV intent without some system wide feedback. And non-AV operators will need some control inputs to discourage aggressive behaviors generally and particularly in the presence of AV vehicles.

Because the majority of vehicle accidents resulting in death occur on high speed national highways, where decision processes overwhelm normal human responses, and where cognitive loading is increasing at a rapid rate due to the rising commercialization of multimedia inputs, where even the geo-mapping systems become a source of cognitive overload, there are potential benefits to a transparent, mechanistic back-channel that can supplement the driving experience and reduce the accident rate. Doing this calls for behavioral modification of vehicles in the short run, which may result in human behavioral modification in the longer term.

Present vehicle collision avoidance systems estimate the probability of collision with another vehicle, issue warnings and alerts, and in some cases even apply the brakes. But they do not communicate that information to surrounding vehicles in a manner that amplifies the severity of multiple vehicle iterations in real-time and feed back an aggregate control solution to each nearby vehicle. As such, present approaches do not generally affect the performance of the second vehicle, which is the proximate cause of the risk, and do not propagate the risk into the surrounding vehicles with long term impact on the risk to a collection of cars.

The herein disclosed systems and methods seek to address these problems, and others.

Successful collision avoidance and road safety in a world of autonomous and semi-autonomous vehicles will depend on being able to modify behaviors in real-time that are precursors to serious highway accidents and fatalities. There are systems which can automatically apply braking to help prevent collisions, but there is no adequate solution for carrying that information forward in time to stabilize the system as a whole. Stochastic systems are inherently unstable and unpredictable. Such systems can benefit from negative feedback to provide enough margin to operate successfully.

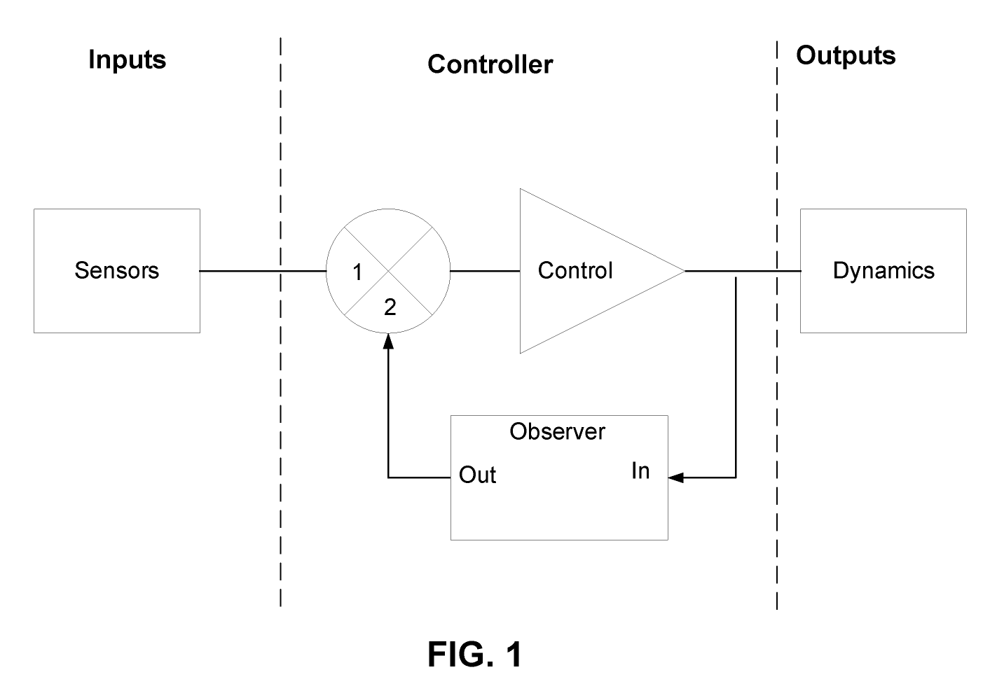

In a simplified negative feedback model, such as depicted in the block diagram of FIG. 1, a driver (e.g., controller) takes in sensory information (inputs) and produces a control output, observes the results and adds additional control to converge on and stabilize the result. In general, for the case of driving, most of the observer inputs are in the form of negative feedback to stabilize the system. The Input contains the normal driving parameters that a driver or AV routinely handles in a controlled fashion. On the Output side, however, is a stochastic mix of road conditions, signage, driver intent, nearby vehicle performance, and hazards, and/or the like. The Control amplifier may be the vehicle controller (such as for AVs) or the driver (for semi-AVs or non-AVs). The Observer block may represent a feedback derived from the observation of position and velocity of other vehicles and their instantaneous performance, fused with the subject vehicles performance. The transfer function of the observer feedback may be determined by either years of driving experience for non-AVs or by sensor and algorithm development in AVs.

In the case of a non-AV, this simple system is inadequate and too often results in injury and death. It is also becoming increasingly clear that the same can be said for an AV operating in a mixed-autonomy system, which is the likely situation for the foreseeable future.

In exemplary embodiments, the driving experience is analyzed within a larger context in which additional stabilizing negative feedback may help reduce the stochastic nature of the system. Exemplary systems and methods disclosed herein add an additional feedforward controller to the simple feedback loop just described to augment the sensory input of the driver (or AV system).

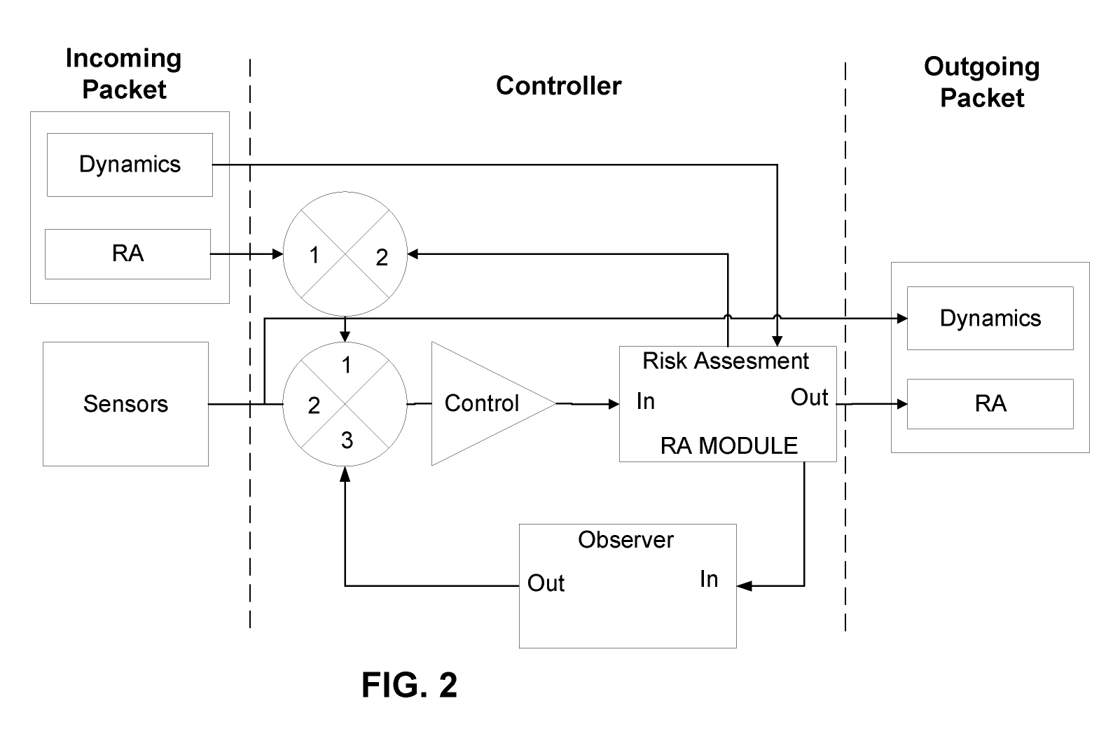

A risk assessment system which utilizes collaborative V2V may be integrated into a vehicle to provide negative feedback, both to the subject vehicle operator and to other nearby vehicles. A block diagram illustrating a Risk Assessment Controller (RAC), according to one embodiment, is depicted in FIG. 2. Risk assessment (RA) involves accurately collecting information about the vehicle's physics, the vehicle's relationship to other vehicles and fusing that information in a manner that provides a risk of collision. Once informed by risk, a vehicle can be properly controlled, even in a benign driving environment, to provide more margin of error. When RA data is pushed forward into the system (or collaborative environment) by V2V messages, a stable control system can be realized.

In one embodiment, a risk assessment controller may comprise: a transmitter; a receiver; a sensor module, configured to receive information detected by at least one sensor of a vehicle; a risk classification module, configured to compute an aggregate collision risk score from data gathered by the sensor module and a weighted sum of received risks from surrounding vehicles; and a driving mode controller module, configured to select a driving mode of a self-driving vehicle based on the aggregate collision risk score computed by the risk classification module.

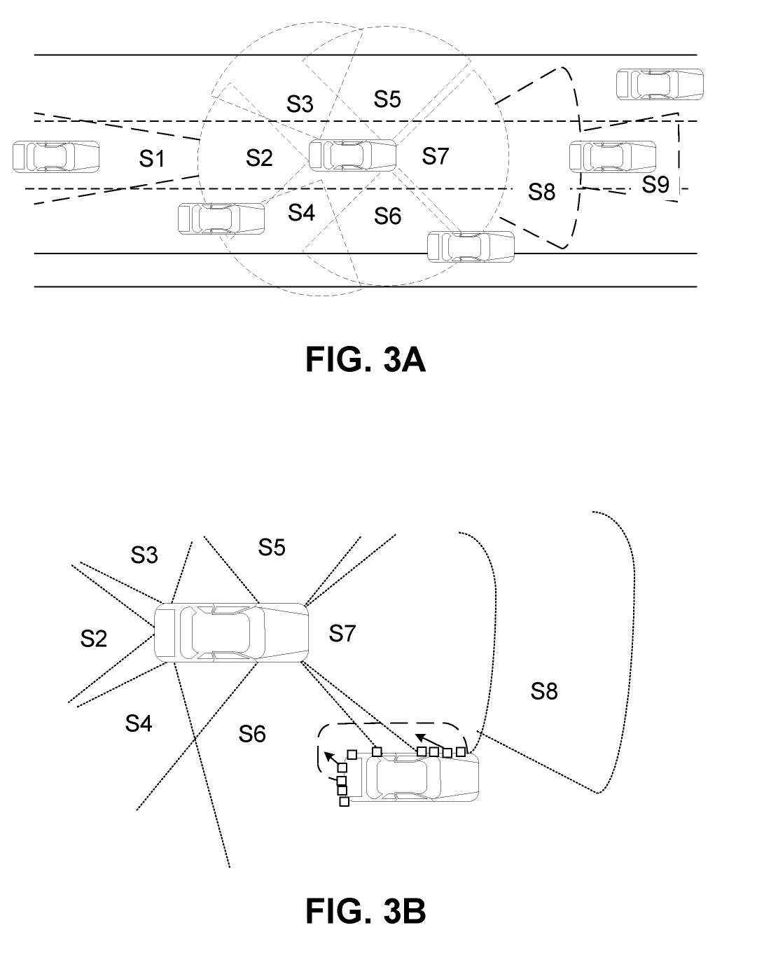

One embodiment of an environment within which the disclosed RAC may operate is depicted in FIGS. 3A and 3B. For example, a particular vehicle's sensors (e.g., S1 through S9) may gather information regarding one or more surrounding vehicles. In some instances, a vehicle may determine edges of a nearby vehicle, as more particularly shown in FIG. 3B.

In some embodiments, a vehicle's sensors may include any or all of: short range radar, multi mode radar, stereo multipurpose cameras, long range radar with mid-range scan, ultrasonic sensors, near/far infrared cameras, and/or the like, as known to one of ordinary skill in the relevant art.

As utilized in the systems and methods disclosed herein, each RA packet encapsulates a learned experience of risk, with a short persistence unless reinforced by additional behaviors. The propagation of the RA may take on a neural property across a set of nearby vehicles, which may persist for a limited time and reflect the localized risk as the sum of the risk of the nearby vehicles as they continually exchange and update RA values according to a decay rule. High risk groups of vehicles, for example clusters of speeders, may continue to carry a high RA with them into a subsequent stretch of road as they leave the group and enter a new regime. Viewed from such a perspective, the local group is sliding and influencing conservative behavior which decays as they pass by. For the speeding cluster, the RA values remain high and continue to dampen speeding behavior.

In the opposing case of a traffic jam, for example one caused by an accident farther along the road, the effect of RA control is to gradually reduce the performance of vehicles approaching denser traffic to a level that is consistent with the threat of additional collisions. The effect may remain as long as the proximity of nearby vehicles requires it, and gradually diminish as vehicles leave the congested area.

Other scenarios may also be addressed by the systems and methods disclosed herein.

For the systems and methods disclosed herein, risk may be computed as a function of relative speed and position, or kinematics, of all nearby vehicles paired with a subject vehicle, updated and integrated over time. The time interval may be a function of vehicle relative speed, communication range, and bandwidth, but is assumed here to be long enough to derive a useful measure. For example, the calculation may be:

RA=ƒ(v,p,θ,t,r) Eq. 1

where v is a relative speed of vehicles, p is a polar coordinate of each nearby vehicle, t is a time interval of pairing, and r is a current risk value of a nearby vehicle.

As packets are exchanged and drive the risk up, a RAC may drive behavior towards more conservative and less risky driving, such as through alerts and control system restraints. This may be an exemplary active use case during a rush hour period. On the other hand, at a less active time, a smaller percentage of vehicles may carry high risk behavior and the RA content may move lower, releasing restraints on the control systems of vehicles. Accordingly, when the risk becomes high subject vehicle performance may be shifted towards more conservative, and the performance of surrounding vehicles may also become more conservative as well. In general, when a vehicle carrying a high P joins a convoy of vehicles and its risk is propagated in the group, its P becomes negative feedback. So leading vehicles in the group gradually acquire the feedback through propagation and the process of risk minimization may begin, potentially earlier, for automated vehicles and/or RAC enabled non-automated vehicles.

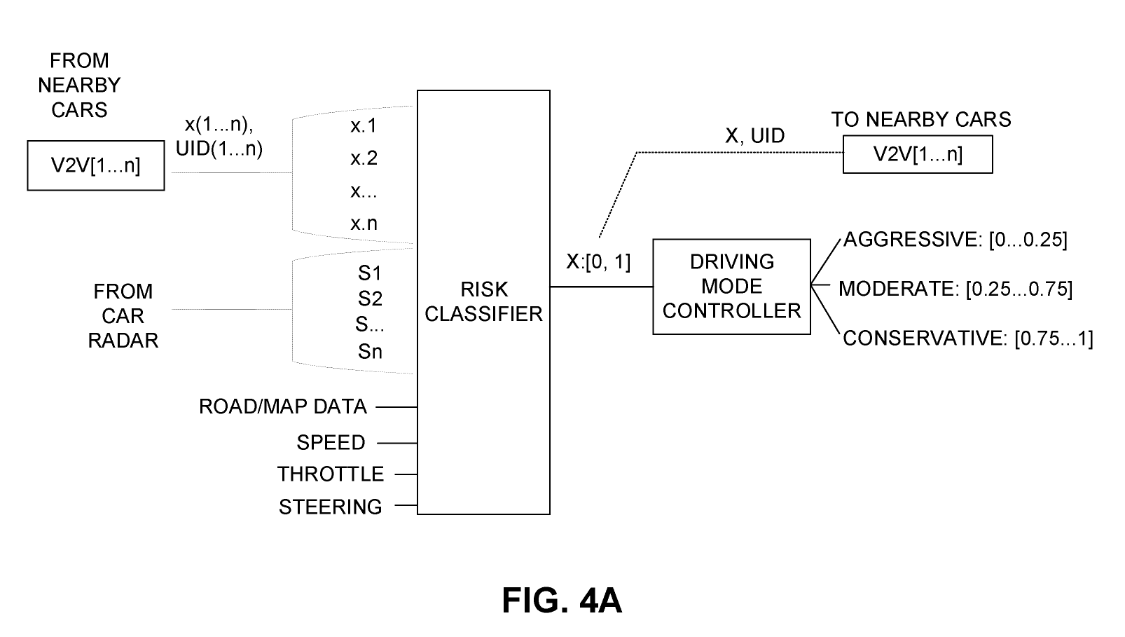

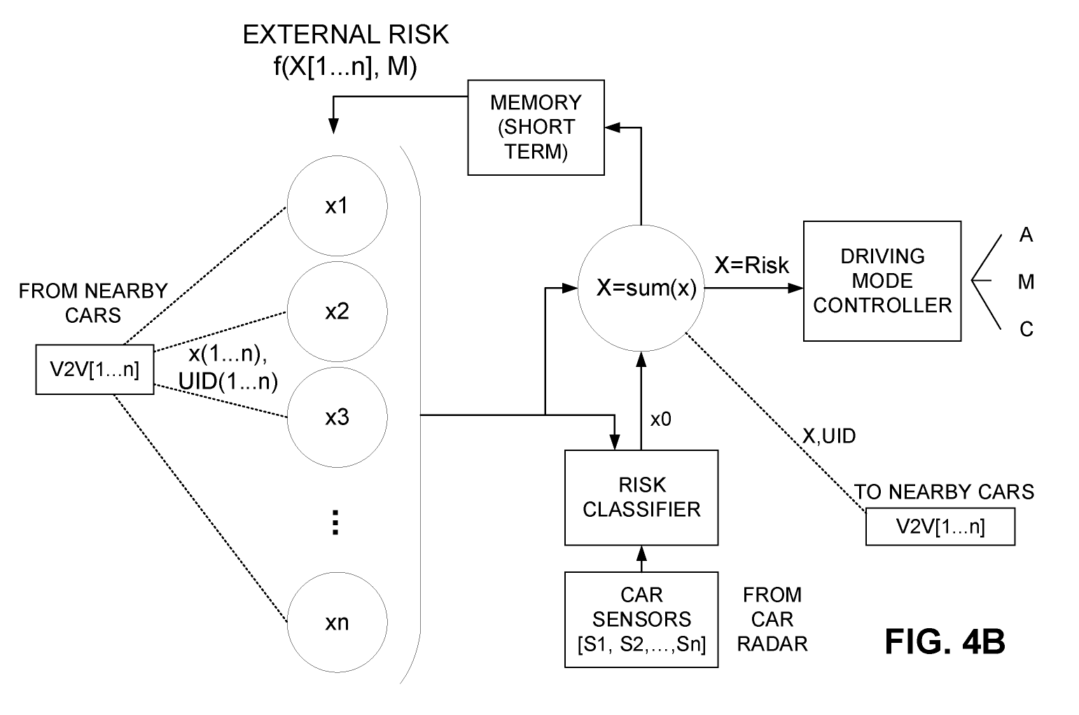

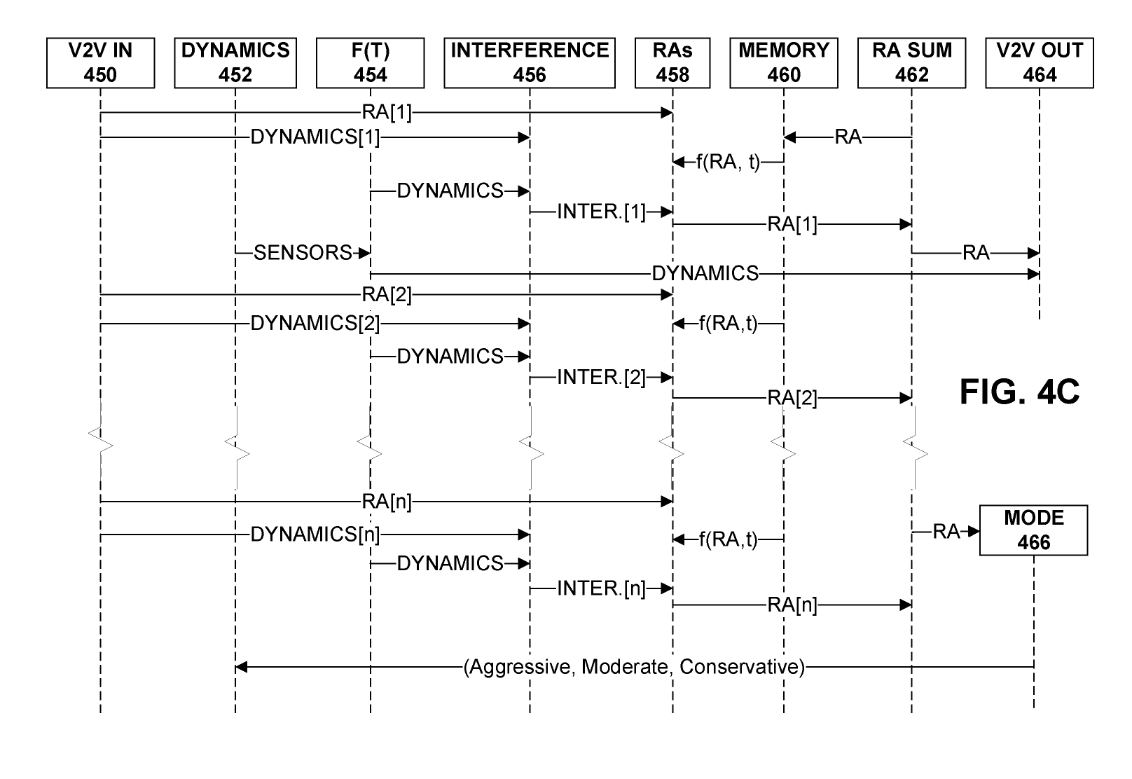

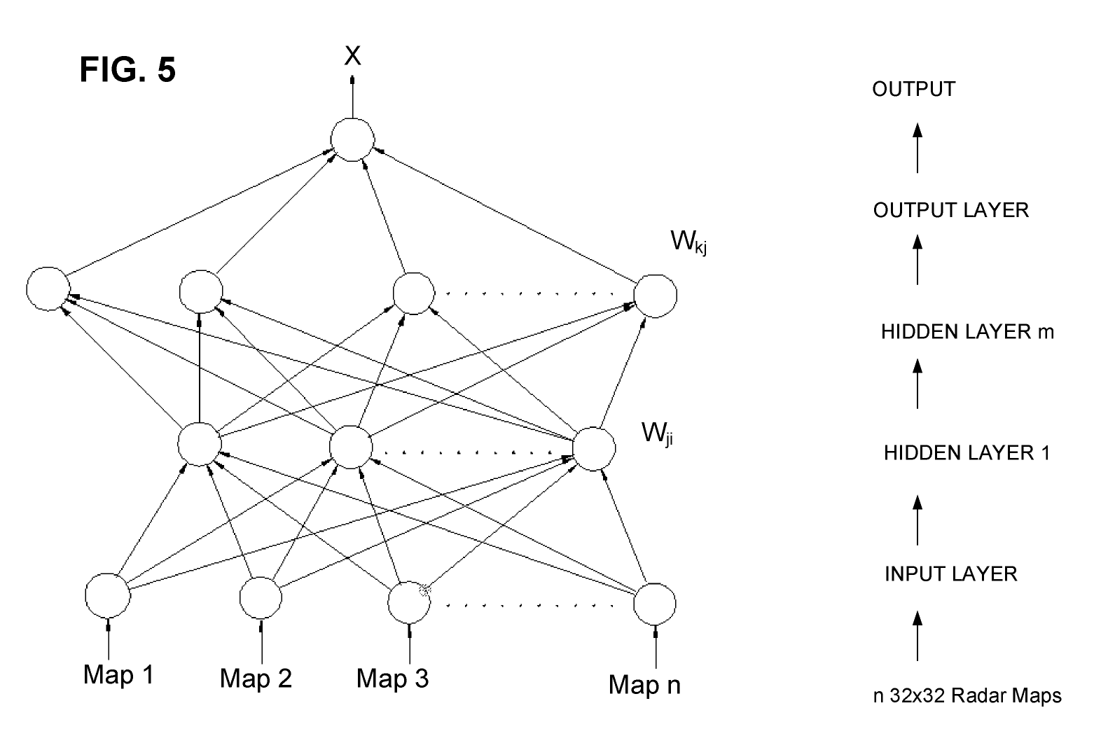

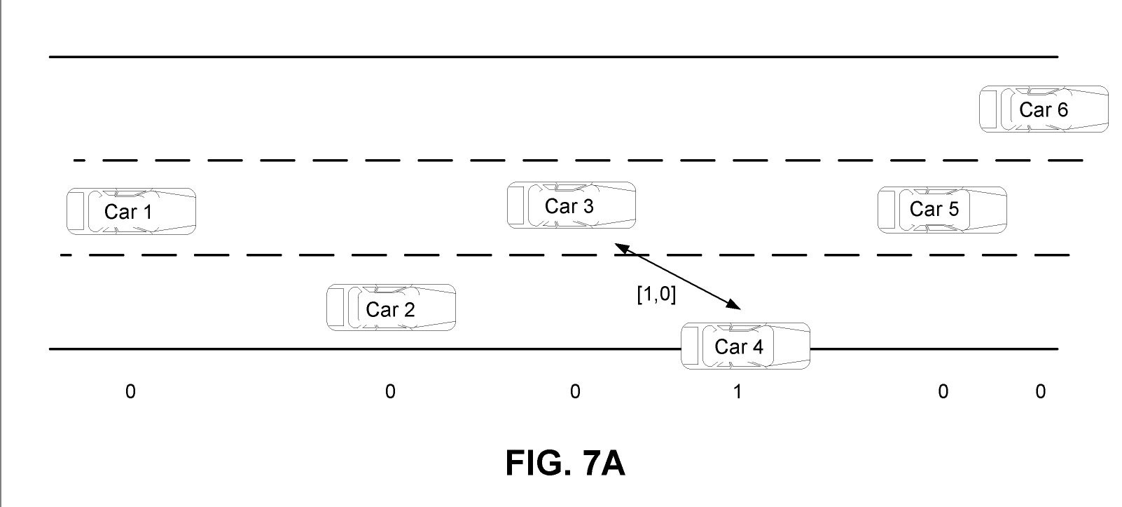

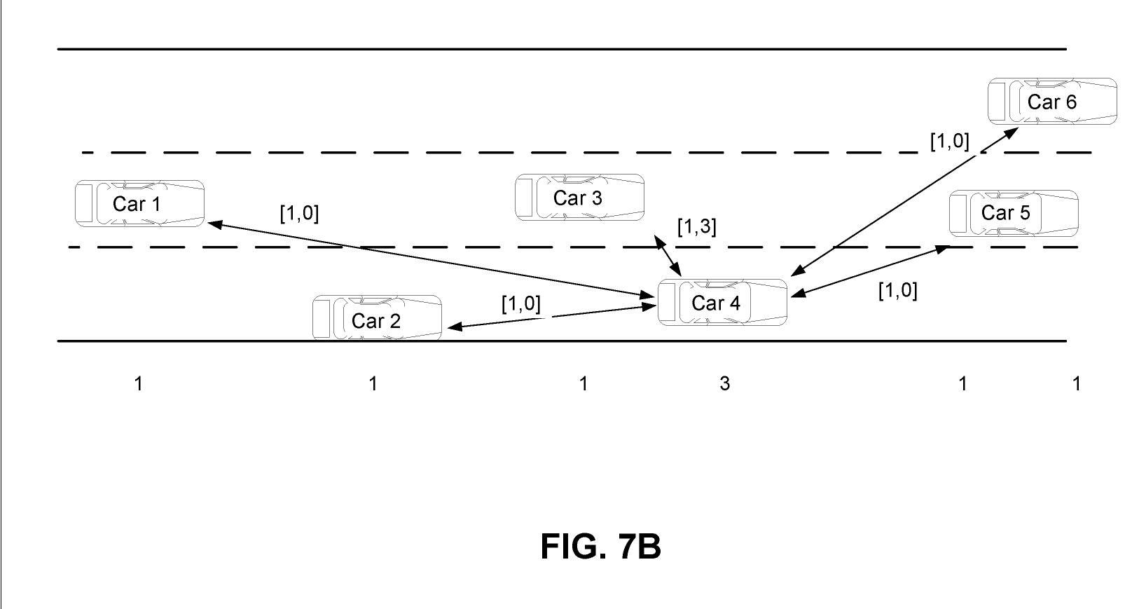

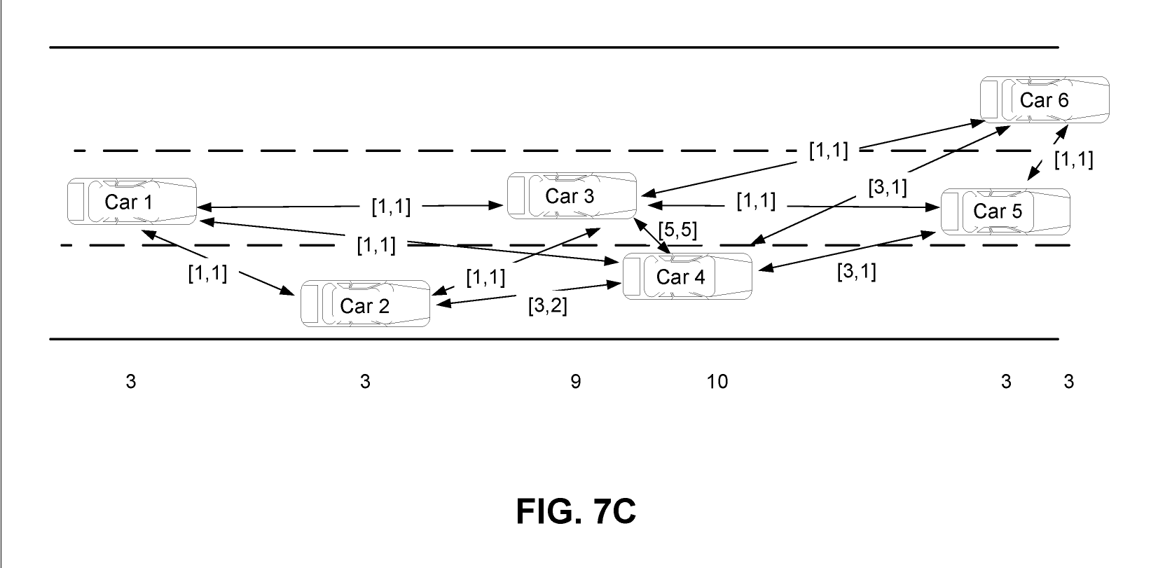

A block diagram illustrating the properties of a RAC, according to one embodiment, is depicted in FIG. 4A. The consequence of this is to have a distributed processing system (such as the car radar RA neural network illustrated in FIG. 5), in which a cost function is being continuously minimized in the Risk Classifier, while the processing nodes are constantly changing. Such a system can be dynamic, reflexive, and adaptable to changing conditions, which is a highly desirable property. In FIG. 4A, the risk is computed by the classifier as the probability that the current risk is equal to 1.0 from the radar maps and the weighted sum of the risk from each surrounding vehicle. This is transmitted by V2V in the response packet to each nearby vehicle as shown in FIGS. 7A-7C. In particular embodiments, the transmission may be triggered in various ways. For example, the calculated risk may be communicated at regular periods, in response to a request, in response to a change of conditions (e.g., in response to an increase of the aggregate collision risk score), and/or the like.

In some embodiments, the risk classifier may also receive road or map data (such as GIS road data), and incorporate this into the risk classification process. For example, upcoming road curves, narrow stretches, on ramps, etc. may be factored into the risk classification.

FIG. 4B illustrates another embodiment of a RAC. While generally similar to the RAC of FIG. 4A, further detail of data flows is illustrated in FIG. 4B. As shown in FIG. 4B, a cost function is being continuously minimized while the processing nodes are constantly changing. The RA value is computed from a weighting factor (such as a temporal decay factor) of risk values x1, x2, . . . , xn from each of the nearby vehicles. The calculated risk values may be stored in memory by the RAC, and constantly updated. The calculated risk X may be utilized by the driving mode controller as well as transmitted by V2V in a response packet to nearby vehicles.

FIG. 4C depicts a sequence diagram for one embodiment of the RAC of FIG. 4B. A particular vehicle may be receiving V2V inputs 450 from nearby vehicles 1, 2, . . . , n. The RA[1] for a first vehicle may be received and used to update the current risks from nearby vehicles (458). The dynamics[1] for the first vehicle may also be received, and passed to an interference module 456. Using the updated values, an RA Sum module 462 may store updated RA in the memory 460. The stored RA may be operated on by a decay factor, and the decayed RA value f(RA,t) used to update the current risks 458. The interference module 456 may also receive the vehicle's own dynamics (454) and compute vehicle trajectories and interference boundaries using the received dynamics and the vehicle's own dynamics (e.g., position, velocity, acceleration). These interference boundaries (Inter[1]) may be incorporated into the current risks from nearby vehicles 458. The received RA[1] may be updated in the RA Sum 462, and an updated RA for the vehicle communicated via V2V to nearby vehicles (464). In some embodiments, the vehicle may gather its sensor data, together with its own dynamics with its sensors, for communication with the updated RA to nearby vehicles. Similar sequences may occur for each nearby vehicle as its V2V communications are received by the current vehicle, up through vehicle n.

In some embodiments, a risk classifier may also consider stored map data (such as upcoming road curves, narrow portions, or the like) to determine the risk assessment. In some embodiments, the risk classifier may also update different decay functions, such as for nearby aggressive vehicles and responsive vehicles, to actively adjust the risk assessment.

At some point, such as after updates have been received from all nearby vehicles, the current updated RA may be evaluated by a driving mode controller 466. Based on the current updated RA, the vehicle may select a driving mode (e.g., aggressive, moderate, conservative), and control its operation (e.g., dynamics) according to such mode.

Calculation of Risk.

The RA score may be adjusted by information collected by a vehicle about its surroundings using its on-board perception sensors. The vehicle may measure the parameters of operation of other vehicles and determine a need to update the RA score. For example, the vehicle may determine a new vehicle has been detected which is driving at a speed above the speed limit and higher than a prespecified safety threshold, and use this information to update the overall RA score. This may eventually cause the vehicle to move to a more conservative mode of operation (e.g., lower speed or larger inter-vehicle distance).

In some embodiments, the RA score may be adjusted based on information received from V2V messaging received by the vehicle. In another embodiment, the RA score adjustment may be triggered by information received from a cloud service, such as Waze.

The threat posed for any vehicle, X, is the summation of a perceived threat, the risk states x of the connected vehicles and the recent risk history of surrounding vehicles. In one embodiment, the summation may be:

Xₜ=Σᵢ₌₁^{p}threat_sensor_{i,t}+Σᵢ₌₁ⁿx_{i,t}+Σⱼ₌₁^{m}Σ_{t′=t-q}^{t-1}ƒⱼ(t−t′)·x_{j,t′} Eq. 2

where: Xₜ is the aggregate risk calculated at the vehicle at time t; threat_sensor is a perceived threat based on sensor measurements by a particular vehicle for each neighboring vehicle; x is the risk received from other vehicles; p is the number of vehicles detected using sensor measurements by the particular vehicle; n is the number of vehicles whose risks have been received by the particular vehicle at time t; m is the number of vehicles whose risks were received in a time window q (e.g., 10 seconds, 30 seconds, 1 minute, etc.); and fⱼ(t−t′) is a decay function for a vehicle j.

In some embodiments, the calculated aggregate risks may be normalized, in any of a variety of well-known manners. For example, normalization may be performed based on a number of cars, counts of cars, different weightings, feature scaling, and/or the like.

The time window q may be maintained as a sliding window to account for remnant risk of the vehicles, that is decayed using the decay function. The decay function and the parameters may be chosen to decay aggressive behavior (e.g., a vehicle creating a risky behavior) more slowly than responsive behavior (e.g., a vehicle reacting to the risky behavior). For example, with reference to FIG. 7C, assume Car 2 has already categorized Car 3 as having moderate behavior and Car 4 as having risky behavior. If Car 3 reacts suddenly to Car 4 almost merging into Car 3, the calculated risk from the reactive behavior of Car 3 may decay more quickly than the calculated risk from the initiating risky behavior of Car 4. In one embodiment, an exponential decay function for a vehicle j may be:

ƒⱼ(Δt)=Aⱼe^{-α}^{ⱼ}^{Δt} Eq. 3

where A is a normalization factor and aⱼ is a decay rate assigned to vehicle j by the particular vehicle. For example, different decay rates may be assigned to vehicles based on determined driving behavior by the particular vehicle, such that a decay rate for vehicles that have demonstrated conservative behavior may be greater than a decay rate for vehicles that have demonstrated risky behavior.

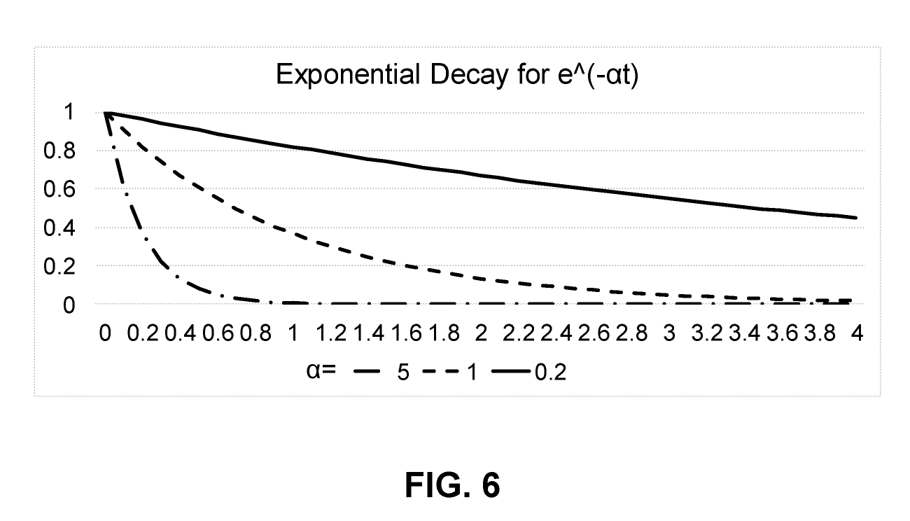

An exemplary decay function for remnant risk factors, in accordance with an embodiment and without limitation, is illustrated in FIG. 6, for three exemplary a values (e.g., as could be used for different categorizations of observed vehicle behaviors). Alternative decay functions such as sigmoid functions may be used in other embodiments.

In one embodiment, the threat posed for any particular vehicle, X, may also account for the aggregated risk associated with a geo-location, threat_location. The threat_location carries a historic average of risk scores associated with a geofenced region or area to account for road regions, intersections, merge areas that are more risky than others, and/or the like. Receiving historical measurements of risk associated with a region allows an AV to adjust its driving behavior to a more conservative mode, as it enters the region.

The equation of the risk may, in an embodiment, be computed as below to account for the location based risk:

Xₜ=Σᵢ₌₁^{p}threat_sensor_{i,t}+Σᵢ₌₁ⁿx_{i,t}+Σⱼ₌₁^{m}Σ_{t′=t-q}^{t-1}ƒⱼ(t−t′)·x_{j,t′}±threat_location_{gps,t} Eq. 4

where threat_location is an aggregated threat received for an area associated with a GPS location of the vehicle (or other location identification methodology).

The threat_location may account for situations such as dangerous intersections with limited turning visibility, intersections or high risk points due to blind spots or highway merges with short merging lanes, i.e., situations which in the past had caused vehicles to calculate high risk scores due to accidents or close encounters. Additionally, the threat_location may account for road conditions such as large angle curvatures or slopes that reduced speed and increased inter-vehicle distances between vehicles. As these factors increase the calculated risk of vehicles in a given location, the calculated values may be stored in a server and provided as offsets to vehicles over infrastructure-to-vehicle or network-to-vehicle communications (or the like).

In one embodiment, vehicles may report the aggregated risk at different locations to a cloud server, for example Waze, or to a roadside infrastructure entity, e.g., a road side unit (RSU). The reporting may be periodic or event driven, for example when the risk rises above a threshold value. In another embodiment, a vehicle may be configured to report risk periodically when the vehicle enters or leaves a geofenced region.

In another embodiment, the threat posed for any vehicle, X, may also account for the aggregated risk due to weather, threat_weather. The threat_weather may be calculated by a server as a scaling value to account for predicted and observed weather conditions in a pre-specified driving radius of the vehicle. Receiving a non-zero threat_weather value may allow an AV to adjust its driving behavior to a more conservative mode, as it enters the region.

The equation of the risk may, in an embodiment, be computed as below to account for the location based risk:

Xₜ=Σᵢ₌₁^{p}threat_sensor_{i,t}+Σᵢ₌₁ⁿx_{i,t}+Σⱼ₌₁^{m}Σ_{t′=t-q}^{t-1}ƒⱼ(t−t′)·x_{j,t′}±threat_weather_{gps,t} Eq. 5

where threat_weather is aggregated threat received for an area associated with a GPS location of the vehicle.

Risk score adjustments for location and/or weather may be received from a cloud or road side unit. For example, when a vehicle approaches hazardous road conditions which suggest a different mode of operation, or due to a change in weather conditions which might suggest a different mode of operation.

Modes of Operation. Referring to FIG. 4A, a risk value, X, computed for a vehicle by the risk classifier may, in addition to being transmitted to other vehicles, be fed to a driving mode controller which may determine an allowed mode of vehicle operation. In some embodiments, the vehicle may change its driving behavior, or mode of operation, based on changes in the RA score.

For example, available modes of operation may be defined as Aggressive, Moderate, or Conservative. If the vehicle is in a low risk probability state, the mode can include any of the three, and possibly other, modes of operation. If the risk probability is midrange, only Moderate and Conservative modes may be allowed.

The user may be provided an audio or visual indication when the vehicle driving in autonomous driving mode changes its mode of operation. For example, a mode of operation may be displayed over a Heads-Up Display (HUD), or in other embodiments as a voice prompt to the user, to improve the users awareness of the behavior of the vehicle.

Each mode of operation may control one or more driving characteristics, such as: inter-vehicle distance maintained with vehicles ahead, behind, or adjacent to the vehicle; speed; acceleration/deceleration limits; driving in blind spots; permission to change lanes; etc.

In some embodiments, the permitted speed or acceleration may be restricted for each mode of operation. The maximum allowed acceleration may be restricted in the conservative mode of operation. In some embodiments, lane changing might be disabled in conservative mode of operation. In some embodiments, the minimum inter-vehicle distance that needs to be maintained between two vehicles may be scaled based on the mode of operation. In some embodiments, driving in the blind spot of a neighboring vehicle may be disabled in a conservative mode of operation. The vehicle may perceive itself to be in blind spot of a neighboring vehicle and change its driving behavior to reduce speed or change position. The vehicle may, in some embodiments, consider either measured dimensions of the neighboring vehicle(s), and/or a detected or received make and model of neighboring vehicles to assess neighboring vehicles' blind spots.

In one embodiment, the mode of driving operation may also take into account a preferred driving experience, depending on user activities in the vehicle. For example, a user may prefer a more or less constant speed and minimization of starts and stops so they may engage with a multimedia session or a virtual reality session. In such a scenario, the inter-vehicle distance may be weighted to allow more distance with other vehicles to support a smoother driving experience.

In another embodiment, a user may prefer the fastest route and may find frequent acceleration and deceleration more acceptable.

Algorithm Illustration.

An exemplary scenario of the described systems and methods is illustrated in FIGS. 7A-7C. Within FIGS. 7A-7C, the arrows represent V2V inquiries and replies, and the numbers on the arrows are the risk values (e.g., x) sent in each case. At the bottom of each panel is the final X for each vehicle above.

In FIG. 7A, Car 3 has detected Car 4 in sensors S6 and S7 (see FIGS. 3A and 3B) coming back onto the highway. In this case, a relatively low pseudo-probability number of 1 has been assigned by the classifier to Car 3, which is then sent by V2V inquiry to Car 4. The reply from Car 4 may include its initial risk score value of 0. Based on the received risk score values at each vehicle, Car 4 has a risk score of 1, and Cars 1, 2, 3, 5, and 6 each have a risk score value of 0.

At the next interval, as depicted in FIG. 7B, Car 4's risk score X (currently 1) is propagated to the five cars near it. In the same interval, Car 3 may detect additional encroachment by Car 4 and assigns a new X value of 3, which is communicated as a reply to Car 4's V2V inquiry. Each of Cars 1, 2, 5, and 6 reply with risk scores of 0 to Car 4's V2V inquiries, resulting in a new risk score of 3 for Car 4. However, based on Car 4's communicated risk score of 1, each of Car's 1, 2, 3, 5, and 6 update their own risk scores to 1.

In FIG. 7C, the process repeats, with each car summing the received risks and propagating a new X to each of its neighbors, reinforcing the risk within the group. By the end of the process instance depicted in FIG. 7C, the risk score values of Car 3 and Car 4 have increased to 9 and 10 respectively, consistent with the threat posed to both. These risks may eventually result in the mode controller reducing the performance level of all affected vehicles until the local risk diminishes.

As previously discussed, the calculated aggregate risk for a vehicle may be normalized in any of a variety of fashions, including but not limited to feature scaling.

Risk Visualization.

In some embodiments, the calculated and received risk profile of neighboring vehicles may be visualized to the user by, for example, a heads-up display. In one method, neighboring vehicles noted in the HUD may be highlighted using domes, with different colors associated with the assessed and/or received risk of each neighboring vehicle. For example, a red dome may indicate a high risk vehicle, a yellow dome may indicate a medium risk vehicle, and a green dome may indicate a low risk vehicle.

In some embodiments, the size of a dome may correspond to the magnitude of the risk associated with the particular vehicle.

In one embodiment, with reference to FIG. 4A, a Car A is equipped with RAC, has a low RA score, and is driving in the left lane and following a vehicle at a normal separation distance. A Car B has a high RA, and approaches Car A in the right lane at a high speed. Car A begins receiving V2V packets from Car B that contain speed and position information with high RA numbers. The new risk assessment for Car A is computed, and, because it is a high RA, the onboard RAC may cause a slight reduction in Car A's speed to improve the margin of safety, while transmitting a high risk RA back to approaching vehicles. Car B may receive the high RA from Car A, and its RAC may cause a reduction in speed sufficient to lower the RA responses from Car A. Car B still merges as intended, but does so more safely.

Because aggressive behaviors are causative, the decay factor for Car B's actions may be longer than for the forced response actions of Car A. As such, the RA value for Car A may return to normal relatively quickly, as Car A interacts in safe driving patterns with other vehicles. But the RA for Car B may remain more persistent, and in some instances so high that even if it approaches a next vehicle more slowly, the reaction to its presence may be much the same. Vehicles may automatically give way to a more aggressive vehicle, but the aggressive vehicle is gradually forced to carry less speed until its RA number decreases. As such, the penalty for aggressive driving results in driving in a lower performance mode in the presence of other vehicles. This penalty may decrease gradually, and disappear over time and traffic conditions.

Identification.

In some embodiments, all RAC equipped vehicles may possess a unique identifier (UID) derived from the MAC address of the controller, or other stable properties. This UID may serve to resolve conflicts regarding vehicles and communication protocols. In particular, the UID may be used in a mixed traffic case, where non-RAC vehicles are detected and integrated into the process

Mixed Traffic.

If a joining vehicle is not RAC enabled, a virtual V2V RA packet may be created, and its RAC score computed and propagated from advanced sensors, such as side scan radars, etc. As such, for vehicles which do not have a RAC, a unique identification (UID) may be created by each nearby vehicle detecting the non-RAC vehicle, and a RA packet injected into the outgoing packet stream.

Each RAC vehicle detecting the non-RAC vehicle may resolve the uniqueness problem based on position and other data. The RA history of the approaching non-RAC vehicle may be carried forward virtually by any RAC vehicle and its computations may be completed with the information available within each RAC vehicle based on the UID.

In one embodiment, there is a control method for a connected vehicle to determine operational risk. The method may comprise receiving, from other vehicles, V2V input. V2V input may include a computed historical risk element, and a probability of interference or collision of said vehicle with proximate vehicles using radar, imagery or other means. In some embodiments, the method may comprise receiving road ahead contours from a map database. In some embodiments, the method may comprise receiving inputs for integrating a probability over time with a risk element in the V2V input for each connected vehicle to produce a new risk element for said vehicle. The method may comprise propagating this risk element to each proximate vehicle.

In one embodiment, there is a method of controlling automated driving behavior of a first self-driving vehicle, comprising: determining a collision risk for the first self-driving vehicle based on a present risk from each vehicle of a first plurality of vehicles; receiving, at the first self-driving vehicle, a collision risk assessment value from each vehicle of a second plurality of vehicles; calculating, at the first self-driving vehicle for a first time window, a historical collision risk for a third plurality of vehicles; determining an aggregate collision risk score based on the first self-driving vehicle's determined collision risk, the received collision risk assessment values, and the calculated historical collision risk; and responsive to the determination that the aggregate collision risk score has increased relative to a previously calculated aggregate collision risk score, adapting a self-driving parameter of the first self-driving vehicle to a more conservative level. The method may also include wherein adapting the self-driving parameter to a more conservative level comprises reducing a maximum allowed driving speed. The method may also include wherein adapting the self-driving parameter to a more conservative level comprises reducing a maximum allowed acceleration. The method may also include wherein adapting the self-driving parameter to a more conservative level comprises disallowing change of lane operations. The method may also include wherein adapting the self-driving parameter to a more conservative level comprises increasing an inter-vehicle distance. The method may also include wherein adapting the self-driving parameter to a more conservative level comprises disallowing driving in blind spots of adjacent vehicles. The method may also include wherein adapting the self-driving parameter to a more conservative level comprises setting a lower value of allowed acceleration or deceleration. The method may also include wherein the determination of the collision risk for the first self-driving vehicle is based at least in part on at least one sensor measurement of the first plurality of vehicles. The method may include wherein the at least one sensor measurement comprises inter-vehicle distance of at least one of the first plurality of vehicles. The method may include wherein the at least one sensor measurement comprises a count of detected vehicles in the first plurality of vehicles. The method may include wherein the at least one sensor measurement comprises a speed of at least one of the first plurality of vehicles. The method may include wherein the at least one sensor measurement comprises acceleration or deceleration of at least one of the first plurality of vehicles. The method may also further comprise receiving, at the first self-driving vehicle, a geolocation-based risk. The method may include wherein the geolocation-based risk is received from a roadside infrastructure entity. The method may include wherein the geolocation-based risk is received from a cloud server. The method may include wherein the aggregate collision risk score is further based on the received geolocation-based risk. The method may also include wherein the aggregate collision risk score is further based on an aggregate risk associated with a weather condition in a pre-specified driving radius around the first self-driving vehicle. The method may include wherein the aggregate risk associated with a weather condition is received at the first self-driving vehicle from a cloud server, and wherein the cloud server calculates the aggregate risk associated with a weather condition as a scaling factor to account for predicted and observed weather conditions in the pre-specified driving radius around the first self-driving vehicle. The method may include wherein the aggregate risk associated with a weather condition is received at the first self-driving vehicle from a roadside infrastructure entity, and wherein the roadside infrastructure entity calculates the aggregate risk associated with a weather condition as a scaling factor to account for predicted and observed weather conditions in the pre-specified driving radius around the first self-driving vehicle.

In one embodiment, there is a method, comprising: determining, at a risk assessment controller of a first self-driving vehicle, a collision risk for the first self-driving vehicle based on a present risk from each vehicle of a first plurality of vehicles; receiving, at the first self-driving vehicle, a collision risk assessment value from each vehicle of a second plurality of vehicles; calculating, at the first self-driving vehicle for a first time window, a historical collision risk for a third plurality of vehicles; determining an aggregate collision risk score based on the first self-driving vehicle's determined collision risk, the received collision risk assessment values, and the calculated historical collision risk; and responsive to the determination that the aggregate collision risk score has changed relative to a previously calculated aggregate collision risk score, the risk assessment controller of the first self-driving vehicle adapting a self-driving parameter of the first self-driving vehicle. The method may also include wherein responsive to a determination that the aggregate collision risk score has dropped below a predefined minimum threshold, enabling from the risk assessment controller selection of any of a plurality of driving operation modes. The method may include wherein the plurality of driving operation modes comprises: an aggressive mode, a moderate mode, and a conservative mode. The method may also further comprise the risk assessment controller selecting a replacement driving operation mode based at least in part on the aggregate collision risk score. The method may further comprise generating an indication to a user of the first self-driving vehicle that the driving operation mode has changed. The method may include wherein the indication comprises a visual indication on a display device of the first self-driving vehicle. The method may include wherein the indication comprises an audio indication. The method may also further comprise visualizing, to a user of the first self-driving vehicle, the received collision risk assessment value from at least one of the second plurality of vehicles. The method may include wherein the visualization comprises generating a dome over the at least one of the second plurality of vehicles within a heads-up display of the first self-driving vehicle. The method may include wherein a size of the generated dome corresponds to a magnitude of the received collision risk assessment for the at least one of the second plurality of vehicles. The method may include wherein the visualization further comprises associating a color indication with the received collision risk assessment from the at least one of the second plurality of vehicles. The method may include wherein a first color is associated with a low risk neighboring vehicle, a second color is associated with a medium risk neighboring vehicle, and a third color is associated with a high risk neighboring vehicle. The method may also include wherein calculating the historical collision risk for the third plurality of vehicles further comprises applying a decay factor to at least one previously received collision risk assessment for at least one of the third plurality of vehicles. The method may include wherein the decay factor for the at least one of the third plurality of vehicles is selected by the risk assessment controller based at least in part on a driving behavior associated with said vehicle. The method may also include wherein the first-self driving vehicle and each of the second plurality of vehicles have a unique identifier, the unique identifier associated with collision risk values transmitted by each vehicle. The method may also further comprise transmitting the determined collision risk of the first self-driving vehicle to at least one of the second plurality of vehicles.

In one embodiment, there is a method of changing an automated driving behavior of a first self-driving vehicle, comprising: determining at least one ego-vehicle environment parameter for the first self-driving vehicle; receiving at least one neighbor vehicle environment parameter from at least a first neighboring vehicle using vehicle-to-vehicle communications; determining at least one situational base parameter based on the at least one ego-vehicle environment parameter, received at least neighbor vehicle environment parameter, and at least one road condition received from a cloud database; and responsive to the determination that a second vehicle has significant deviation relative to the at least one situational base parameter, adapting a self-driving parameter of the first self-driving vehicle. The method may also further comprise transmitting an indication of increased perceived collision risk from the first self-driving vehicle using vehicle-to-vehicle communications. The method may also include wherein the at least one ego-vehicle environment parameter comprises a sensor measurement by the first self-driving vehicle of at least one of: an inter-vehicle distance; a count of detected vehicles; a speed of at least one neighboring vehicle; and acceleration/deceleration data of at least one neighboring vehicle.

In one embodiment, there is a method to change an automated driving behavior of a first self-driving vehicle, comprising: determining, at a risk assessment controller of the first self-driving vehicle, a collision risk for the first self-driving vehicle; receiving, at the first self-driving vehicle, from at least a second vehicle, a collision risk assessment value determined by each of the at least second vehicles, using vehicle-to-vehicle communications; determining an aggregate collision risk score based on the first self-driving vehicle's determined collision risk and the collision risk assessment received from at least the second vehicle; and responsive to a determination that the aggregate collision risk score has changed relative to a previously calculated aggregate collision risk score, the risk assessment controller adapting a self-driving parameter of the first self-driving vehicle. The method may also further comprise transmitting an indication of changed perceived collision risk using vehicle-to-vehicle communications, from the first self-driving vehicle to at least the second vehicle. The method may also include wherein responsive to a determination that the aggregate collision risk score has increased, the risk assessment controller of the first self-driving vehicle adapting the self-driving parameter of the first self-driving vehicle to a more conservative level. The method may include wherein adapting the self-driving parameter to a more conservative level comprises at least one of: reducing a maximum allowed driving speed; reducing a maximum allowed acceleration; disallowing change of lane operations; increasing an inter-vehicle distance; disallowing driving in blind spots of adjacent vehicles; and setting a lower value of allowed acceleration or deceleration. The method may also include wherein the determination of the collision risk for the first self-driving vehicle is based at least in part on at least one sensor measurement of detected neighboring vehicles in proximity to the first self-driving vehicle. The method may include wherein the at least one sensor measurement of detected neighboring vehicles comprises at least one of: inter-vehicle distance; a count of detected vehicles; a speed of at least one neighboring vehicle; and acceleration or deceleration of at least one neighboring vehicle. The method may also include wherein the aggregate collision risk score is further based on an aggregate risk associated with a location of the first self-driving vehicle. The method may include wherein the aggregate risk associated with the location of the first self-driving vehicle is received from a roadside infrastructure entity. The method may further comprise transmitting, after a predefined period, the aggregate risk score from the first self-driving vehicle to the roadside infrastructure entity. The method may include wherein the aggregate risk associated with the location of the first self-driving vehicle is received from a cloud server. The method may further comprise transmitting, after a predefined period, the aggregate risk score from the first self-driving vehicle to the cloud server. The method may also include wherein the aggregate collision risk score is further based on an aggregate risk associated with a weather condition in a pre-specified driving radius around the first self-driving vehicle. The method may include wherein the aggregate risk associated with a weather condition is received at the first self-driving vehicle from a cloud server, and wherein the cloud server calculates the aggregate risk associated with a weather condition as a scaling factor to account for predicted and observed weather conditions in the pre-specified driving radius around the first self-driving vehicle. The method may include wherein the aggregate risk associated with a weather condition is received at the first self-driving vehicle from a roadside infrastructure unit, and wherein the roadside infrastructure unit calculates the aggregate risk associated with a weather condition as a scaling factor to account for predicted and observed weather conditions in the pre-specified driving radius around the first self-driving vehicle. The method may also include wherein responsive to a determination that the aggregate collision risk score has dropped below a predefined minimum threshold, enabling from the risk assessment controller selection of any of a plurality of driving operation modes. The method may include wherein the plurality of driving operation modes comprises: an aggressive mode, a moderate mode, and a conservative mode. The method may also further comprise selecting a replacement driving operation mode based at least in part on the aggregate collision risk score. The method may further comprise generating an indication to a user of the first self-driving vehicle that the driving operation mode has changed. The method may include wherein the indication comprises a visual indication on a display device of the first self-driving vehicle. The method may include wherein the indication comprises an audio indication. The method may also further comprise visualizing, to a user of the first self-driving vehicle, the received collision risk assessment value from at least the second vehicle. The method may include wherein the visualization comprises generating a dome over the second vehicle within a heads-up display of the first self-driving vehicle. The method may include wherein a size of the generated dome corresponds to a magnitude of the received collision risk assessment for the second vehicle. The method may include wherein the visualization further comprises associating a color indication with the received collision risk assessment from at least the second vehicle. The method may include wherein a first color is associated with a low risk neighboring vehicle, a second color is associated with a medium risk neighboring vehicle, and a third color is associated with a high risk neighboring vehicle. The method may also include wherein determining the aggregate collision risk score further comprises applying a decay factor to at least one previously received collision risk assessment. The method may include wherein for each previously received collision risk assessment, the decay factor is selected based at least in part on a driving behavior associated with the vehicle from which the collision risk assessment was received. The method may also include wherein each of the first and second vehicles have a unique identifier, the unique identifier associated with collision risk values transmitted by each vehicle.

In one embodiment, there is a method to change an automated driving behavior of a first self-driving vehicle, comprising: determining, at a risk assessment controller of the first self-driving vehicle, a collision risk for the first self-driving vehicle; receiving, at the first self-driving vehicle, from at least a second vehicle, a collision risk assessment value determined by each of the at least second vehicles, using vehicle-to-vehicle communications; determining an aggregate collision risk score based on the first self-driving vehicle's determined collision risk and the collision risk assessment received from at least the second vehicle; and responsive to a determination that the aggregate collision risk score has increased relative to a previously calculated aggregate collision risk score, transmitting an indication of increased perceived collision risk using vehicle-to-vehicle communications, from the first self-driving vehicle to at least the second vehicle.

In one embodiment, there is a method, comprising: calculating, at a risk assessment controller of a first vehicle, based at least in part on sensor data of a first sensor of the first vehicle, a self-vehicle collision risk score; transmitting via V2V the first vehicle's calculated self-vehicle collision risk score, to at least a second vehicle; receiving, responsive to the transmission, a collision risk score from at least a second vehicle; determining, at the risk assessment controller, an aggregate collision risk score based on the self-vehicle collision risk score and the at least one received collision risk score; and responsive to the aggregate collision risk score, adapting a current driving mode of the first vehicle. The method may also further comprise responsive to the aggregate collision risk score communicating a perceived collision risk from the first vehicle via V2V.

In one embodiment, there is a risk assessment controller, comprising: a transmitter; a receiver; a sensor module, configured to receive information detected by at least one sensor of a vehicle; a risk classification module, configured to compute an aggregate collision risk score from data gathered by the sensor module and a weighted sum of received risks from surrounding vehicles; and a driving mode controller module, configured to select a driving mode of a self-driving vehicle based on the aggregate collision risk score computed by the risk classification module.

In one embodiment, there is a system comprising a processor and a non-transitory storage medium storing instructions operative, when executed on the processor, to perform functions including: determining a collision risk for a first self-driving vehicle based on a present risk from each vehicle of a first plurality of vehicles; receiving, at the first self-driving vehicle, a collision risk assessment value from each vehicle of a second plurality of vehicles; calculating, at the first self-driving vehicle for a first time window, a historical collision risk for a third plurality of vehicles; determining an aggregate collision risk score based on the first self-driving vehicle's determined collision risk, the received collision risk assessment values, and the calculated historical collision risk; and responsive to the determination that the aggregate collision risk score has increased relative to a previously calculated aggregate collision risk score, adapting a self-driving parameter of the first self-driving vehicle to a more conservative level.

In one embodiment, there is a system comprising a processor and a non-transitory storage medium storing instructions operative, when executed on the processor, to perform functions including: determining, at a risk assessment controller of a first self-driving vehicle, a collision risk for the first self-driving vehicle based on a present risk from each vehicle of a first plurality of vehicles; receiving, at the first self-driving vehicle, a collision risk assessment value from each vehicle of a second plurality of vehicles; calculating, at the first self-driving vehicle for a first time window, a historical collision risk for a third plurality of vehicles; determining an aggregate collision risk score based on the first self-driving vehicle's determined collision risk, the received collision risk assessment values, and the calculated historical collision risk; and responsive to the determination that the aggregate collision risk score has changed relative to a previously calculated aggregate collision risk score, the risk assessment controller of the first self-driving vehicle adapting a self-driving parameter of the first self-driving vehicle.

In one embodiment, there is a system comprising a processor and a non-transitory storage medium storing instructions operative, when executed on the processor, to perform functions including: determining at least one ego-vehicle environment parameter for the first self-driving vehicle; receiving at least one neighbor vehicle environment parameter from at least a first neighboring vehicle using vehicle-to-vehicle communications; determining at least one situational base parameter based on the at least one ego-vehicle environment parameter, received at least neighbor vehicle environment parameter, and at least one road condition received from a cloud database; and responsive to the determination that a second vehicle has significant deviation relative to the at least one situational base parameter, adapting a self-driving parameter of the first self-driving vehicle.

In one embodiment, there is a system comprising a processor and a non-transitory storage medium storing instructions operative, when executed on the processor, to perform functions including: determining, at a risk assessment controller of the first self-driving vehicle, a collision risk for the first self-driving vehicle; receiving, at the first self-driving vehicle, from at least a second vehicle, a collision risk assessment value determined by each of the at least second vehicles, using vehicle-to-vehicle communications; determining an aggregate collision risk score based on the first self-driving vehicle's determined collision risk and the collision risk assessment received from at least the second vehicle; and responsive to a determination that the aggregate collision risk score has changed relative to a previously calculated aggregate collision risk score, transmitting an indication of changed perceived collision risk using vehicle-to-vehicle communications, from the first self-driving vehicle to at least the second vehicle.

In one embodiment, there is a system comprising a processor and a non-transitory storage medium storing instructions operative, when executed on the processor, to perform functions including: calculating, at a risk assessment controller of a first vehicle, based at least in part on sensor data of a first sensor of the first vehicle, a self-vehicle collision risk score; transmitting via V2V the first vehicle's calculated self-vehicle collision risk score, to at least a second vehicle; receiving, responsive to the transmission, a collision risk score from at least a second vehicle; determining, at the risk assessment controller, an aggregate collision risk score based on the self-vehicle collision risk score and the at least one received collision risk score; and responsive to the aggregate collision risk score, adapting a current driving mode of the first vehicle.

Exemplary embodiments disclosed herein are implemented using one or more wired and/or wireless network nodes, such as a wireless transmit/receive unit (WTRU) or other network entity.

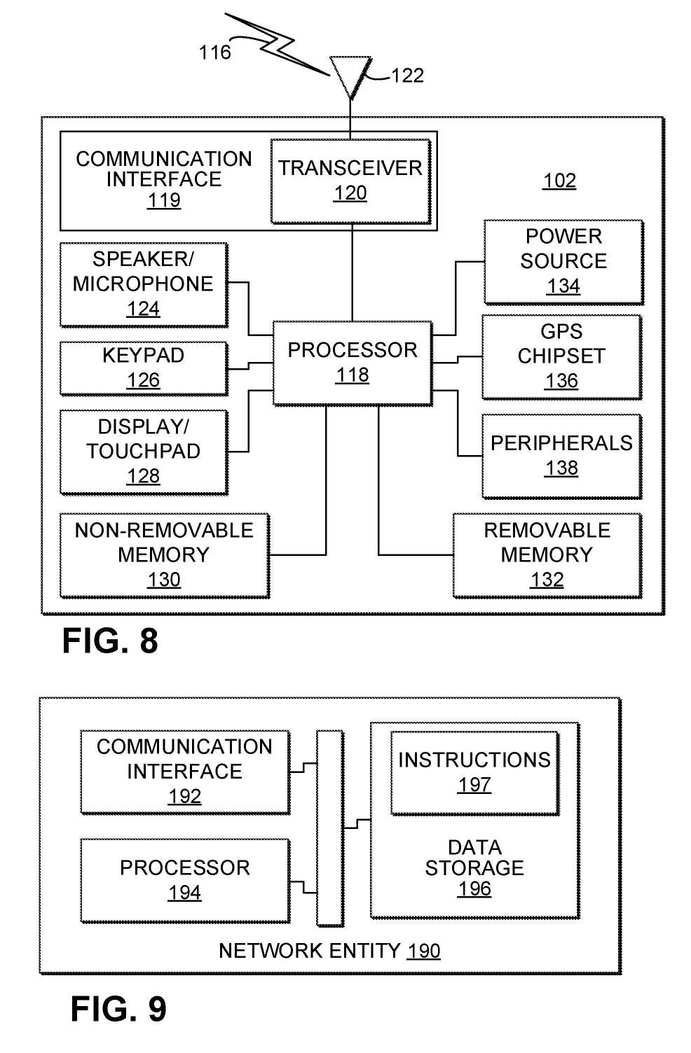

FIG. 8 is a system diagram of an exemplary WTRU 102, which may be employed as a component of a RAC in embodiments described herein. As shown in FIG. 8, the WTRU 102 may include a processor 118, a communication interface 119 including a transceiver 120, a transmit/receive element 122, a speaker/microphone 124, a keypad 126, a display/touchpad 128, a non-removable memory 130, a removable memory 132, a power source 134, a global positioning system (GPS) chipset 136, and sensors 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 8 depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, as examples. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 8 as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, as examples.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. As examples, the power source 134 may include one or more dry cell batteries (e.g., nickel-cadmium (NiCd), nickel-zinc (NiZn), nickel metal hydride (NiMH), lithium-ion (Li-ion), and the like), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include sensors such as an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 9 depicts an exemplary network entity 190 that may be used in embodiments of the present disclosure. As depicted in FIG. 9, network entity 190 includes a communication interface 192, a processor 194, and non-transitory data storage 196, all of which are communicatively linked by a bus, network, or other communication path 198.

Communication interface 192 may include one or more wired communication interfaces and/or one or more wireless-communication interfaces. With respect to wired communication, communication interface 192 may include one or more interfaces such as Ethernet interfaces, as an example. With respect to wireless communication, communication interface 192 may include components such as one or more antennae, one or more transceivers/chipsets designed and configured for one or more types of wireless (e.g., LTE) communication, and/or any other components deemed suitable by those of skill in the relevant art. And further with respect to wireless communication, communication interface 192 may be equipped at a scale and with a configuration appropriate for acting on the network side—as opposed to the client side—of wireless communications (e.g., LTE communications, Wi-Fi communications, and the like). Thus, communication interface 192 may include the appropriate equipment and circuitry (perhaps including multiple transceivers) for serving multiple mobile stations, UEs, or other access terminals in a coverage area.

Processor 194 may include one or more processors of any type deemed suitable by those of skill in the relevant art, some examples including a general-purpose microprocessor and a dedicated DSP.

Data storage 196 may take the form of any non-transitory computer-readable medium or combination of such media, some examples including flash memory, read-only memory (ROM), and random-access memory (RAM) to name but a few, as any one or more types of non-transitory data storage deemed suitable by those of skill in the relevant art could be used. As depicted in FIG. 9, data storage 196 contains program instructions 197 executable by processor 194 for carrying out various combinations of the various network-entity functions described herein.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method to change an automated driving behavior of a first self-driving vehicle, comprising:
determining, at a first self-driving vehicle, a collision risk for the first self-driving vehicle;
receiving, at the first self-driving vehicle, from at least a second vehicle, a collision risk assessment value determined by each of the at least second vehicles, using vehicle-to-vehicle communications;
determining an aggregate collision risk score based on the first self-driving vehicle's determined collision risk and the collision risk assessment received from at least the second vehicle; and
responsive to a determination that the aggregate collision risk score has changed relative to a previously calculated aggregate collision risk score, adapting a self-driving parameter of the first self-driving vehicle.

2. The method of claim 1, further comprising transmitting an indication of changed perceived collision risk using vehicle-to-vehicle communications, from the first self-driving vehicle to at least the second vehicle.

3. The method of claim 2, further comprising transmit collected vehicle sensor data from the first vehicle to the second vehicle.

4. The method of claim 1, wherein responsive to a determination that the aggregate collision risk score has increased, the self-driving parameter of the first self-driving vehicle is adapted to a more conservative level.

5. The method of claim 1, wherein the determination of the collision risk for the first self-driving vehicle is based at least in part on at least one sensor measurement of detected neighboring vehicles in proximity to the first self-driving vehicle.

6. The method of claim 1, wherein the aggregate collision risk score is further based on an aggregate risk associated with a location of the first self-driving vehicle.

7. The method of claim 1, wherein the aggregate collision risk score is further based on an aggregate risk associated with a weather condition in a pre-specified driving radius around the first self-driving vehicle.

8. The method of claim 1, wherein responsive to a determination that the aggregate collision risk score has dropped below a predefined minimum threshold, enabling from the risk assessment controller selection of any of a plurality of driving operation modes.

9. The method of claim 1, further comprising selecting a replacement driving operation mode based at least in part on the aggregate collision risk score.

10. The method of claim 1, further comprising visualizing, to a user of the first self-driving vehicle, the received collision risk assessment value from at least the second vehicle.

11. The method of claim 9, wherein the visualization further comprises associating a color indication with the received collision risk assessment from at least the second vehicle.

12. The method of claim 1, wherein determining the aggregate collision risk score further comprises applying a decay factor to at least one previously received collision risk assessment.

13. The method of claim 11, wherein for each previously received collision risk assessment, the decay factor is selected based at least in part on a driving behavior associated with the vehicle from which the collision risk assessment was received.

14. The method of claim 1, wherein each of the first and second vehicles have a unique identifier, the unique identifier associated with collision risk values transmitted by each vehicle.

15. The method of claim 1, further comprising:
receiving, at the first self-driving vehicle, from the second vehicle, information about current dynamics of the second vehicle;
computing a vehicle trajectory for the second vehicle based on the received dynamics of the second vehicle;
calculating an interference boundary between the first vehicle and the second vehicle; and
updating, at the risk assessment controller of the first self-driving vehicle, the collision risk for the first self-driving vehicle based at least in part on the interference boundary between the first and second vehicles.

16. The method of claim 1, further comprising:
receiving collected vehicle sensor data from the second vehicle; and
updating, at the risk assessment controller of the first self-driving vehicle, the collision risk for the first self-driving vehicle based at least in part on the received vehicle sensor data from the second vehicle.

17. The method of claim 1, further comprising:
obtaining map data indicating at least one upcoming road condition; and
updating, at the risk assessment controller of the first self-driving vehicle, the collision risk for the first self-driving vehicle based at least in part on the at least one indicated upcoming road condition.

18. The method of claim 1, further comprising determining a historical collision risk, and wherein the determination of the aggregate collision risk score is further based on the determined historical collision risk.

19. A system comprising a processor and a non-transitory computer-readable storage medium storing instructions operative, when executed on the processor, to perform functions including:
determining, at a first self-driving vehicle, a collision risk for the first self-driving vehicle;
receiving, at the first self-driving vehicle, from at least a second vehicle, a collision risk assessment value determined by each of the at least second vehicles, using vehicle-to-vehicle communications;
determining an aggregate collision risk score based on the first self-driving vehicle's determined collision risk and the collision risk assessment received from at least the second vehicle; and
responsive to a determination that the aggregate collision risk score has changed relative to a previously calculated aggregate collision risk score, adapting a self-driving parameter of the first self-driving vehicle.
